(19) United States
(12) Patent Application Publication
(10) Pub. No.: US 2014/0249895 A1
(43) Pub. Date: Sep. 4, 2014

(54) SYSTEMS AND METHODS FOR ENABLING ELECTRONIC VOTING

(71) Applicants: Todd Kenneth Anderson, Scottsdale, AZ (US); Michael Arthur Domer, Scottsdale, AZ (US)

(72) Inventors: Todd Kenneth Anderson, Scottsdale, AZ (US); Michael Arthur Domer, Scottsdale, AZ (US)

(21) Appl. No.: 14/099,801

(22) Filed: Dec. 6, 2013

Related U.S. Application Data
(60) Provisional application No. 61/734,250, filed on Dec. 6, 2012.

(51) Int. Cl. G07C 13/00; G06Q 30/02

(52) U.S. Cl. CPC G07C 13/00; G06Q 30/0277
USPC 705/12

(57) ABSTRACT

Aspects of the present disclosure involve systems and methods for engaging in votes and/or voting related activities. According to various aspects, a voting poll may be generated including one or more voting questions and/or prompts that enable users to provide voting responses. Any received votes may be transmitted to a vote management system which applies the vote to one or more of the voting questions included within the voting poll. Once a vote has been received, the vote management system may maintain the integrity of a vote by prohibiting double votes.

### CROSS REFERENCE TO RELATED APPLICATION

The present non-provisional utility application claims priority under 35 U.S.C. §119(e) to co-pending provisional application No. 61/734,250 entitled “Systems And Methods For Enabling Electronic Voting,” filed on Dec. 6, 2012, and which is hereby incorporated by reference herein.

### TECHNICAL FIELD

Aspects of the present disclosure relate to voting, and in particular, systems and method for enabling customized voting sessions.

### BACKGROUND

The use of computing devices, and in particular mobile devices, has become a ubiquitous part of daily life. Users are constantly relying on such devices to conduct business transactions, engage in social interactions, and/or the like. Some mobile devices and related applications allow users to engage in vote-like activities, such as, for example, submitting votes in response to polled events, questions, etc. However, these conventional voting devices and/or applications only allow users to participate in pre-defined and static voting engagements. Stated differently, such devices and/or applications are incapable of generating dynamic voting event/poll, or dynamically incorporating relevant and appropriate multimedia content within a voting event/poll. It is with these concepts in mind, among others, that various aspects of the present disclosure were conceived.

### SUMMARY

Aspects of the present disclosure relate to voting, and in particular, systems and method for enabling customized voting sessions. Specifically, aspects of the present disclosure include methods for automatic voting. The method, which is executable by at least a processor, includes generating a poll including at least one voting question. The method further includes identifying at least one advertisement corresponding to the poll. The method includes serving a polling interface including the at least one voting question and the at least one advertisement to at least one client device, the client device being used by a user. The method includes receiving a response from the at least one client device, the response comprising a vote corresponding to the at least one voting question and a unique identifier associated with the particular user.

Aspects of the present disclosure include systems for automatic voting. The system includes at least one processor configured to generate a poll including at least one voting question. The at least one processor is further configured to identify at least one advertisement corresponding to the poll. The at least one processor is configured to serve a polling interface including the at least one voting question and the at least one advertisement to at least one client device, the client device being used by a user. The at least one processor is configured to receive a response from the at least one client device, the response comprising a vote corresponding to the at least one voting question and a unique identifier associated with the particular user.

Aspects of the present disclosure include non-transitory computer readable mediums encoded with instructions for automatic voting. The instructions include generating a poll including at least one voting question. The instructions include identifying at least one advertisement corresponding to the poll. The instructions includes serving a polling interface including the at least one voting question and the at least one advertisement to at least one client device, the client device being used by a user. The instructions include receiving a response from the at least one client device, the response comprising a vote corresponding to the at least one voting question and a unique identifier associated with the particular user.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1 is a block diagram illustrating a computing system according to aspects of the present disclosure.

FIG. 2 is a block diagram of a vote management system according to aspects of the present disclosure.

FIG. 3 is a flowchart illustrating an example process for enabling voting, according to aspects of the present disclosure.

FIGS. 4A-4F are example polling and/or voting interfaces, according to aspects of the present disclosure.

FIG. 5 is a block diagram of a computer, according to aspects of the present disclosure.

### DETAILED DESCRIPTION

Aspects of the present disclosure describe systems and methods for engaging in votes and/or voting related activities. In various aspects, a voting poll may be generated including one or more voting questions and/or prompts (collectively referred to herein as “voting questions”) that enable users to provide voting responses. The generated poll may be transmitted from the client device to the vote management system, which processes and subsequently applies the vote to one or more of the voting questions. Once a vote has been received from a particular client device for a specific voting question, the vote management system may maintain the integrity of a vote by prohibiting double votes. In particular, the vote management system may implement and/or execute various processes and/or procedures to ensure that only one vote is received from a particular client device for the particular voting question. Any vote responses received may be stored by the vote management system and associated with a particular user.

Aspects of the present disclosure further include associating one or more advertisements with any generated voting questions (collectively referred to as “voting question(s)”). In various aspects, one or more advertisements or other visual, audio, video, and/or multimedia content may be identified and subsequently associated with one of the voting questions included with the vote poll. Subsequently, the identified advertisement or content may be transmitted in conjunction with the voting questions via the generate vote poll to the one or more client devices for access by users.

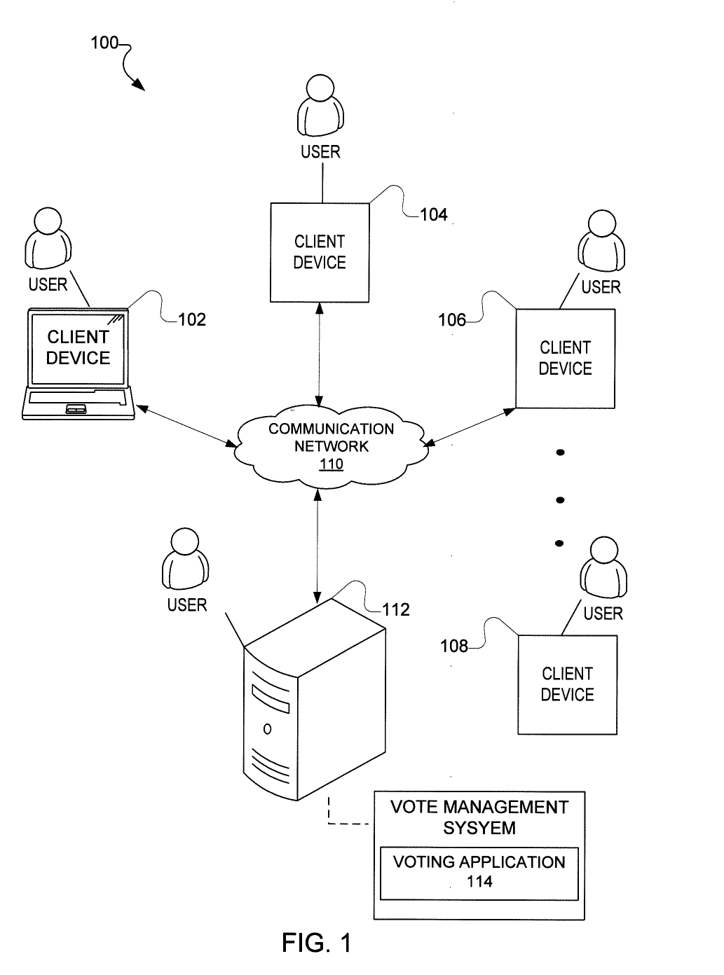

FIG. 1 illustrates an example computing system 100 suitable for implementing various embodiments disclosed herein. Users intending to participate in and/or otherwise submit a vote in response to voting questions may access the system 100 by interacting with client devices 102-108, which may be a personal computer, work station, server, mobile device, mobile phone, processor, and/or other processing device, and may include or otherwise be equipped with various interface components capable of receiving, presenting, and/or interacting a vote poll and/or voting questions. For example, in one particular embodiment, each client device 102-108 may be a client device of any suitable type and may include: a communication system to communicate via a wireline and/or wireless communications, such as through the Internet, an intranet, and Ethernet network, a wireline network, a wireless network, and/or another communication network; a display (not shown) for viewing data, such as a computer monitor; and an input/output device (not shown), such as a keyboard or a pointing device (e.g., a mouse, trackball, pen, touch pad, or other device) for entering data and navigating through data, such as audio, video, and/or other multimedia data.

The client devices 102-108 may receive voting questions from, and transmit votes to, a voting application 114 of a vote management platform 112 via a communication network 110, which may be the Internet, an Intranet, a local area network, a wireless local network, a wide area network, or another communication network, as well as combinations of networks and may transmit such data according to various protocols as are generally known in the art, such as an Internet Protocol/Transmission Control Protocol (IP/TCP), or other protocol. As will be described in more detail below, the voting application 114 includes various processes and/or instructions, which when executed, automatically generate a vote poll including one or more voting questions that may be transmitted to various users at the client devices 102-108.

The vote management platform 112 may be a personal computer, work station, server, mobile device, processor, and/or other processing system and may include one or more processors that process software or other machine-readable instructions, such as the instructions, processes, and/or functions of the voting application 114. The vote management platform 112 may include a memory, which may include volatile and/or non-volatile memory, to store the software or other machine-readable instructions and data. Additionally, the vote management system 112 may include a communication system to communicate via a wireline and/or wireless communications, such as through the Internet, an intranet, and Ethernet network, a wireline network, a wireless network, and/or another communication network, such as the communication network 110. The vote management system 112 may further include a display (not shown) for viewing data, such as a computer monitor, and an input device (not shown), such as a keyboard or a pointing device (e.g., a mouse, trackball, pen, touch pad, or other device) for entering data and navigating through data, including exams, images, documents, structured data, unstructured data, HTML pages, other web pages, and other data.

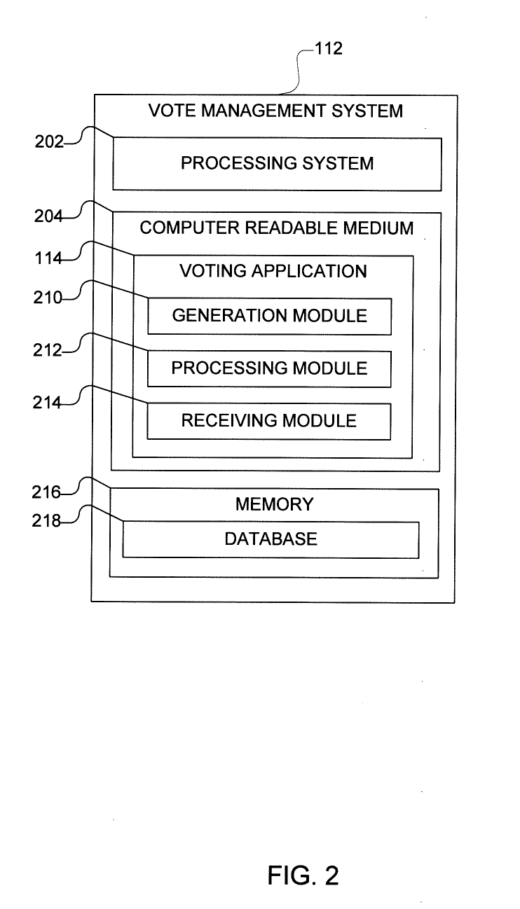

FIG. 2 is an example block diagram illustrating the various hardware and/or software components of the vote management system 112 according to one embodiment of the present disclosure. The vote management system 112 may include a processor 202 that may be used to execute the voting application 114 that automatically generates a vote poll including one or more voting questions for transmission to a client device (e.g., client devices 102-108). The processor 202 may include memory and/or be in communication with a memory 216, which may include volatile and/or non-volatile memory and may also include various other processing computing components. The vote management system 112 may further include a database 218, which may be a general repository of data including vote data, voting question data, voting prompt data, vote responses, user profile data, and/or any other data relating to the automatic generation of vote polls, voting questions, prompts, etc. The database 218 may include memory and one or more processors or processing systems to receive, process, query and transmit communications and store and retrieve such data. In another aspect, the database 218 may be a database server.

Returning to FIG. 2, the vote management system 112 may include a computer readable media (“CRM”) 204, which may include computer storage media, communication media, and/or another available computer readable media medium that can be accessed by the processor 202. For example, CRM 204 may include non-transient computer storage media and communication media. By way of example and not limitation, computer storage media includes memory, volatile media, non-volatile media, removable media, and/or non-removable media implemented in a method or technology for storage of information, such as machine/computer readable/executable instructions, data structures, program modules, or other data. Communication media may further include machine/computer readable/executable instructions, data structures, program modules, or other data. The CRM 204 may store executable instructions to implement the voting application 114. Generally, program modules include routines, programs, instructions, objects, components, data structures, etc., that perform particular tasks or implement particular abstract data types. For example, the voting application 114 may include: a generation module 210, a processing module 212, and a receiving module 214, as will be described in further detail below.

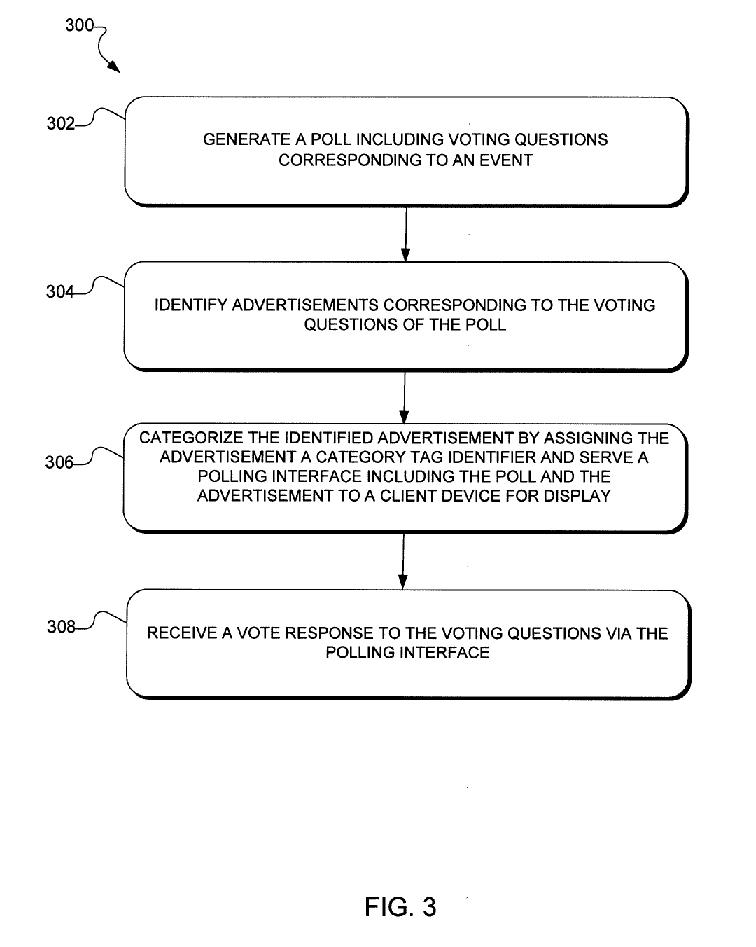

Referring now to the method depicted in FIG. 3, as well as FIGS. 1-2, in one particular embodiment, the vote management system 112 may launch, run, execute, interpret, or otherwise perform the logical instructions and/or processes of the voting application 114. In one example, the vote management system 112 may implement and run the process 300 of the voting application 114, shown in FIG. 3, which depicts an example method and/or process for defining and/or generating one or more voting questions for which users may submit corresponding votes using the client devices 102-108.

As illustrated, process 300 begins with generating a vote poll including one or more voting questions for a voting event (operation 302). More specifically, as illustrated in FIG. 2, a generation module 210 may generate a voting “poll” interface (referred to herein as a “Poll”) that enables users to define one or more voting questions for transmission to the client devices 102-108. Accordingly, a request to generate a Poll may be received from a user engaging the vote management platform 112, such as for example an administrative user, and in response, the generation module 210 may transmit instructions that may be processed and/or executed to generate, or otherwise display, one or more interactive interfaces (e.g., a user-interface) for configuring and/or generating a Poll. The user-interfaces may include various interactive elements, such as buttons, forms, fields, selections, inputs, streams, etc., for receiving input to configure various components, attributes, etc., corresponding to the Poll, as well as various components for defining any voting questions to be included within the Poll.

A Poll may be generated for any type of organized event in which a user engaged in the event is able to submit a vote corresponding to a particular outcome, option, opinion, decision and/or the like. The types of events for which one or more Polls may be generated include corporate and/or political elections, such as voting to select a particular candidate to a corporate or political office. Other types of Polled events include sporting events in which various voting questions corresponding to various aspects of the sporting event are generated.

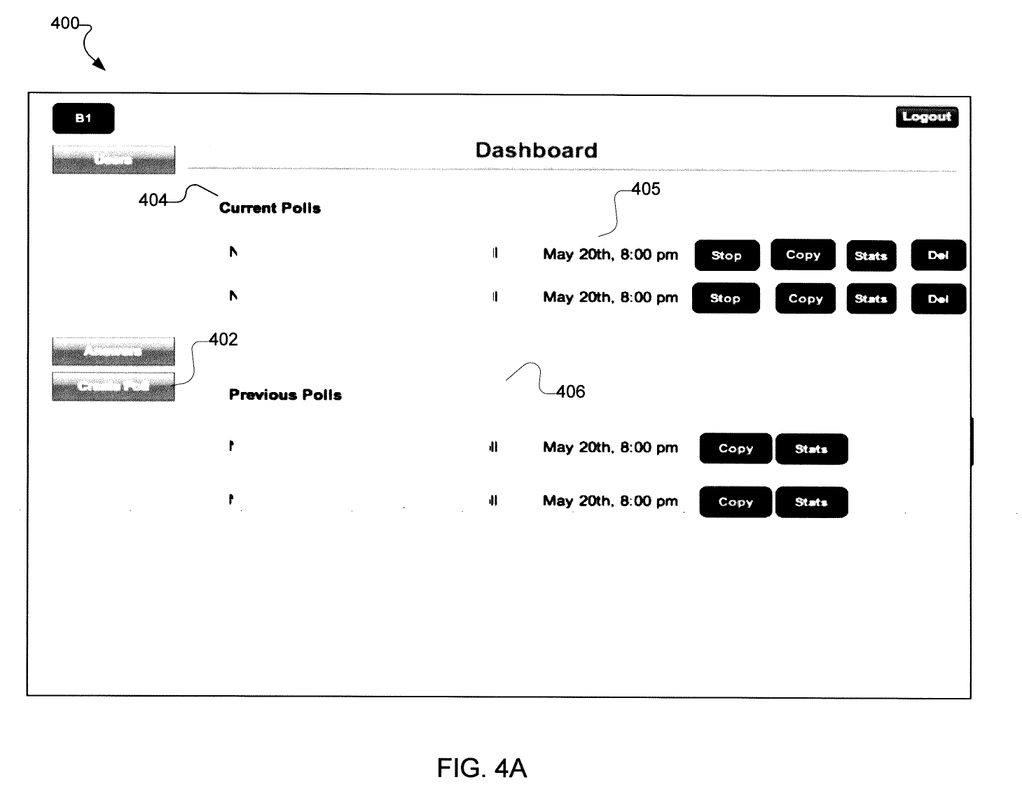

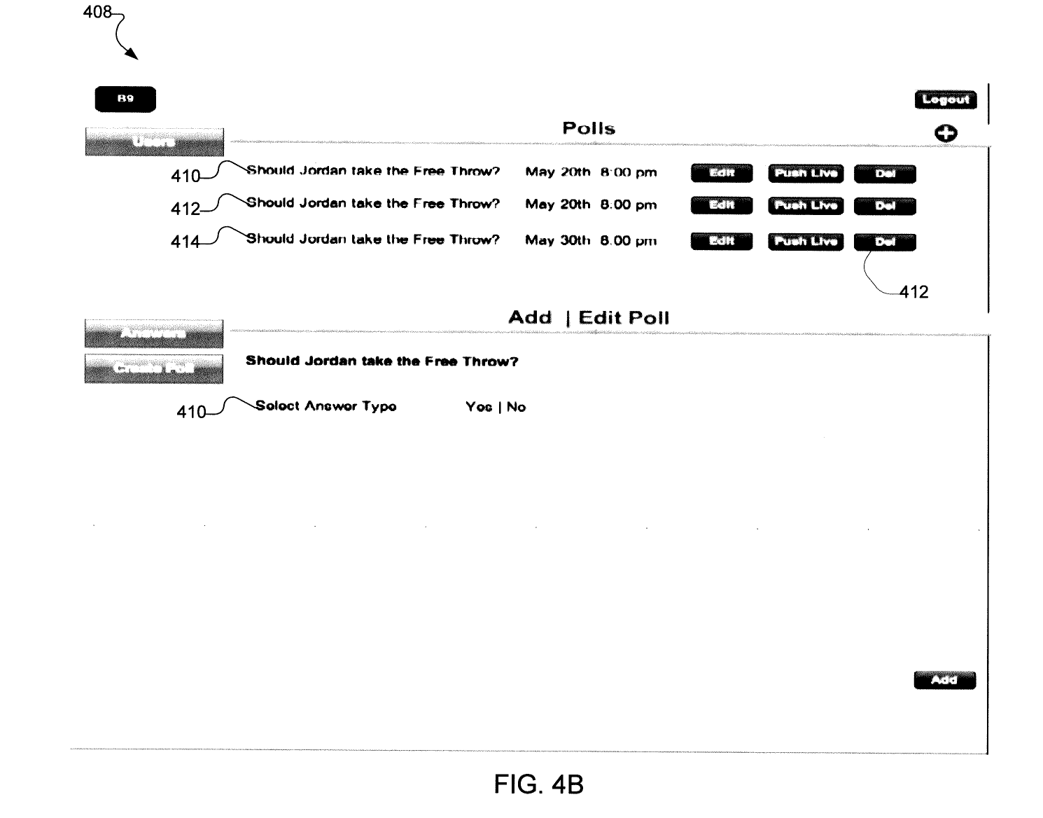

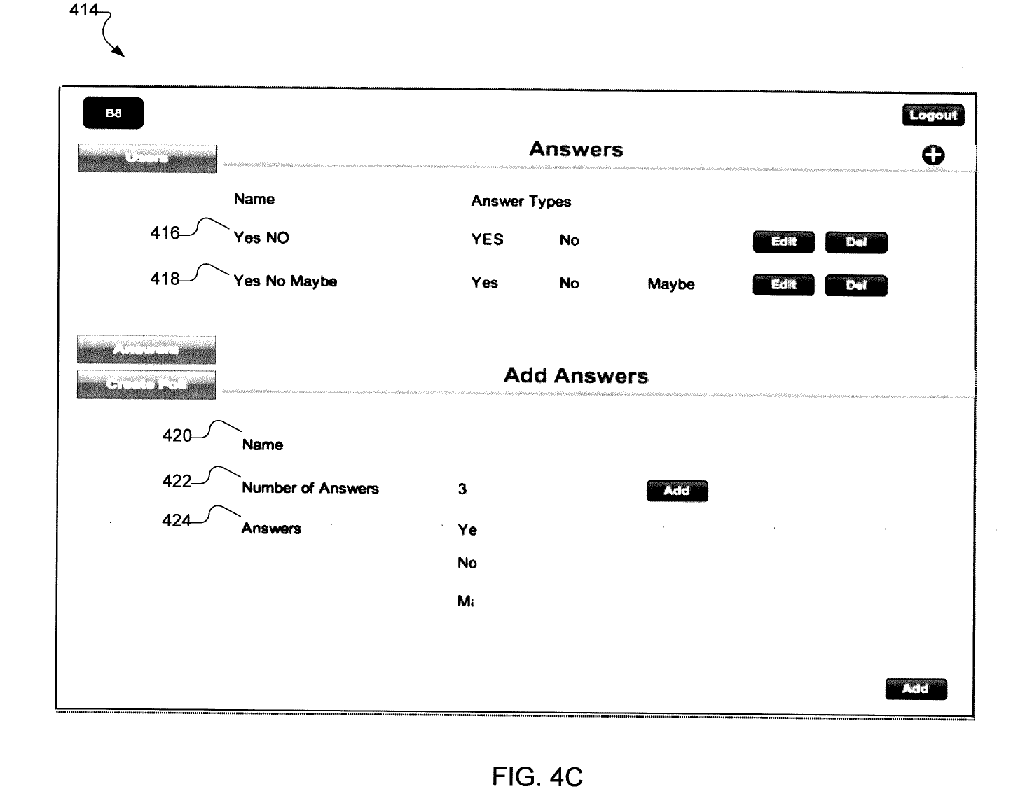

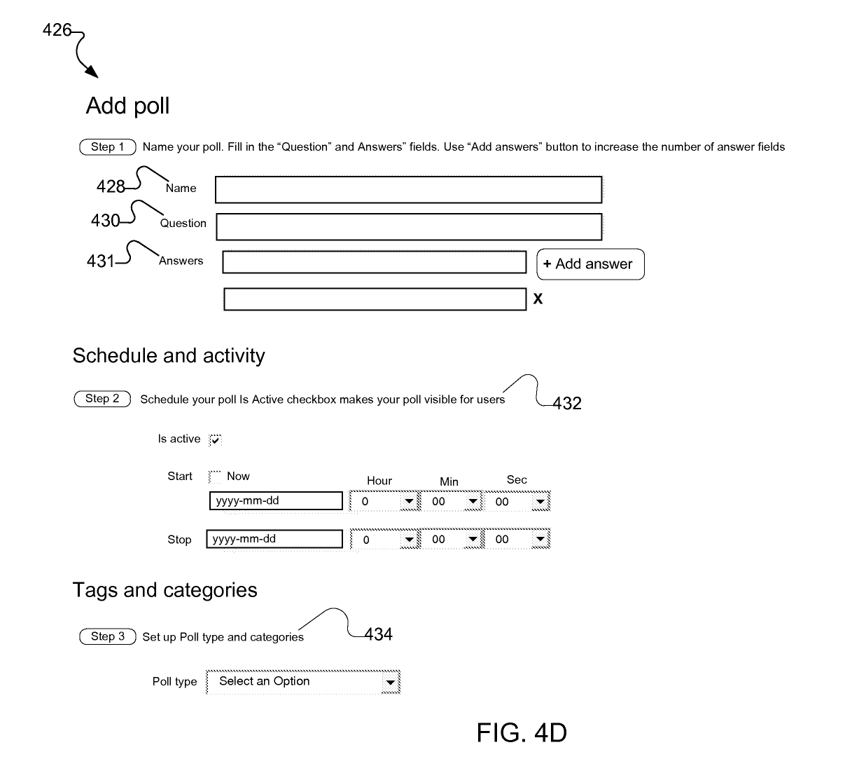

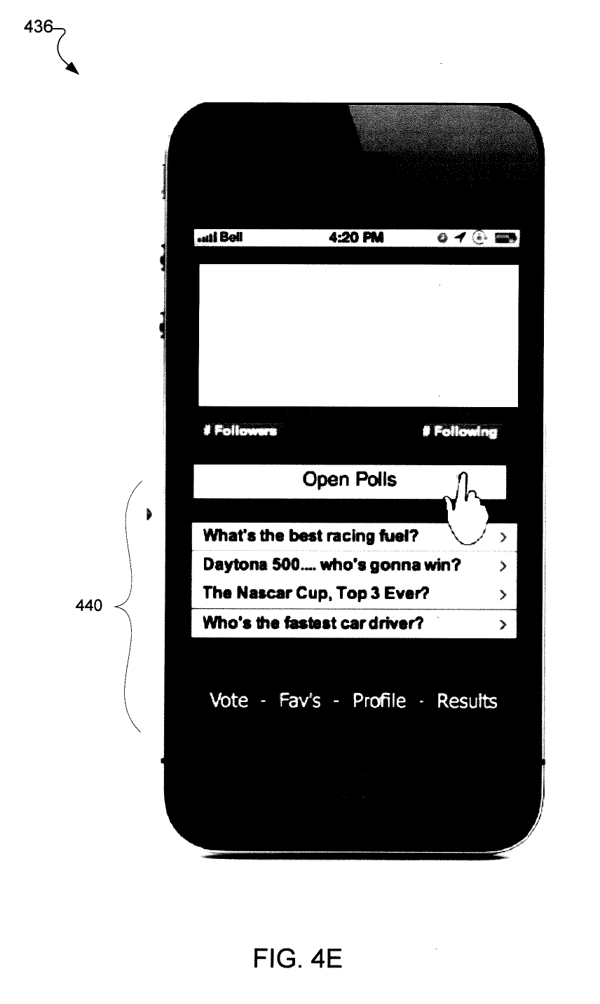

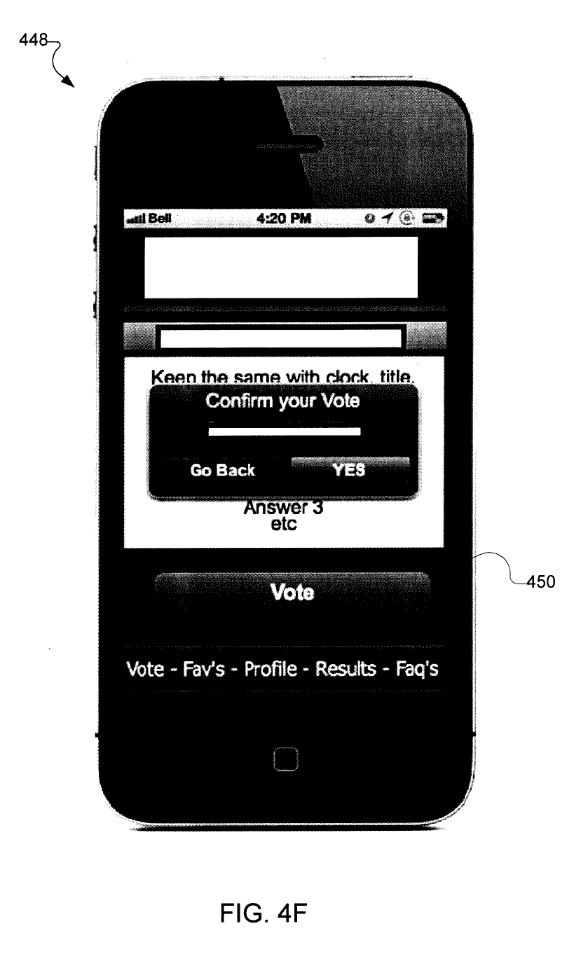

FIGS. 4A-4D illustrate various Poll interfaces that may be generated by the voting application 114 of the vote management system 112. As illustrated in FIG. 4A, an interface 400 is depicted that enables a user, such as an administrator, to create a Poll 402. Additionally, the interface may depict one or more current Polls 404 and/or previous Polls 406. The user may create a Poll and identify the time the Poll should be activated for use at 405. When a user selects create Poll 402, a Poll interface 408 may be generated that enables the user to define one or more voting questions 410-414. In the illustrated embodiment, the voting questions relate to whether a basketball player named “Jordan” should take a free throw.

In addition to defining voting questions (i.e. voting questions 410-414) the user may also define one or more answers. In the illustrated embodiment, two possible answers are identified: yes or no, at 410. Other information surrounding the Poll 402 may be provided such as a scheduling time for when the Poll should be made active and viewable to other users (at 412). While only one voting question is depicted in FIG. 4B, it is contemplated that multiple questions and answers may be defined within a single Poll. FIG. 4C is an illustrative Poll interface 414 corresponding to the type of answers that may be associated with a voting question. In the illustrated embodiment, a user has defined a “Yes No” answer 416 with two different answer types: yes and no; a “Yes No Maybe” answer 418 with three different answer types: yes and no and maybe. Additionally, the user may add any number of answers using the add selections 420. For example, the user may define an answer name 422, define a number of selectable answers at 424, and provide the relevant answers at 426. In addition to identifying answers when creating a Poll, the user may identify a particular answer that is considered the most correct answer. Such a feature may be used in a predictive type Poll. For example, assume a Poll is generated surrounding a football game and includes the voting question “It is 4th down and 1 to go, what action should the team take? Run, Pass, Field Goal, or Punt.” After the football gameplay resumes and the Poll has closed (e.g., a time limit corresponding to the Poll has expired), the outcome is realized and a user can access the Poll to flag or otherwise indicate the correct answer on the completed Poll.

FIG. 4D is an alternative Poll generation interface 426 and includes similar function as FIG. 4A, as well as one or more interactive components that enable a user to assign the Poll to a particular category, as described above. Thus, as illustrated, FIG. 4D includes a section for generating a name of a Poll event 428 and the ability to generate one or more voting questions 430 and one or more answers 431 corresponding to the generated questions. Additionally, a scheduling section 432 allows a user to configure when the Poll should be active to users, how long the Poll should be active (e.g., a time limit), when the Poll should end, and the like Finally, the interface 426 includes a section 434 for assigning a category tag to the generated Poll. For example, the Poll may be assigned or otherwise tagged to an “entertainment” category.

In yet another embodiment, when generating a Poll, a user may have the ability to associate the Poll with a precise geographical location, such as a country, state, city, address, GPS location, and the like. Once a location has been identified, the user may identify an exact radius from the specified location in which other users may access the poll. Stated differently, if a user, for example, at one of the client devices 102-108, wants to access the generated Poll, the user may first be within the acceptable geographic area determined by the Poll, effectively defining a limit on who can see and interact with the Poll.

An illustrative example of a voting event and the generation of one or more voting questions corresponding to the event will now be provided. Assume hundreds of fans are attending a major league baseball game and the announcer is interested in what one or more fans predict will occur during the next at bat. Thus, the announcer interacts with the voting application 114 of the vote management system 112 to submit a Poll generation request to generate a Poll related to major league baseball, and in particular, batting predictions for a given batter. In response, one or more Poll interfaces (e.g., interfaces 4A and 4D) may be generated by the vote management system 112. To generate voting questions corresponding to the Poll, the announcer interacts with the generated Poll interfaces to define or otherwise configure various voting questions within the Poll such as: “batter will strike out, batter will hit into out, batter will walk, and batter will get a hit.” The generated voting questions may be stored or otherwise maintained in the database 218.

Referring back to FIG. 3, after a Poll including one or more voting questions is generated, advertisements corresponding to the Poll are identified (operation 304). As shown in FIG. 2, a processing module 212 may identify one or more advertisements for display at the client devices 102-108. For example, in one particular embodiment, one or more advertisements may be selected that correspond to the subject matter and/or content of the generated voting questions of the Poll. Stated differently, when a user, such as an administrative user, defines a voting question within a Poll, the user may also identify and/or otherwise provide a relevant advertisement. The advertisements may be displayed as a portion of the various Poll interfaces generated by the generation module 210. Thus, the advertisements may be viewed by users engaging or otherwise interacting with a Poll, or when responding to a voting question included within a Poll. Referring to the major league baseball example above, one or more advertisements corresponding to all, or a portion of, the voting questions—batter will strike out, batter will hit into out, batter will walk, and batter will get a hit—may be identified and provided for display.

According to one embodiment, demographic information may be collected and retained corresponding to the users, which may be used to identify relevant advertisements that should be provided to a user for display, such as via a polling interface. For example, advertisements may be identified according to a user's age, sexual orientation, interests, and the like. In yet another embodiment, an advertisement may be associated with a particular geographic location. Stated differently, the advertisements identified for display via a Poll interface may only be applied to specific geographic locations associated with the advertisement, if any. Referring to the major league baseball example above, assume that a geographical location of the baseball stadium is associated with all of the advertisements corresponding to the generated voting questions (i.e., the batter will strike out, batter will hit into out, batter will walk, and batter will get a hit). As a result, the advertisements will only be provided to users that are located within the baseball stadium. As another example, an organization such as a large department store could elect to have advertisements displayed only in Chicago; thus, only users located in the Chicago area would be able to view or otherwise access and interact with the advertisements.

Referring again to FIG. 3, any identified advertisement may be categorized into one or more groups by assigning or otherwise associating a category tag with each identified advertisement, thereby creating a specific subset of advertisements (operation 306). Each advertisement within the subset includes the same tag identifier. Thus, when a user, such as an administrative user, defines a Poll including a voting question and identifies a relevant advertisement, the user may also associate with the advertisement a category tag that categorizes the advertisement in a specific subgroup. In one particular embodiment, an advertisement may be grouped in a “main” category such as a politics, sports, lifestyle, or comedy category, etc.

The category tag may be used to map categories of advertisements with the generated Poll. Stated differently, each Poll includes a category tag and any relevant advertisements are associated and/or connected to the Poll category tag, thereby mapping the advertisement to the Poll. Referring to the major league baseball example described above, assume three advertisements were identified. Two of the advertisements were categorized as “Sports merchandise” and one of the advertisements was tagged or otherwise categorized as “food purchases,” The generated Poll included a poll category identifier identifying the “Sports merchandise” category. Thus, only Sports merchandise advertisements will be displayed for the particular Poll.

Additionally, the category of advertisements may be used to determine a priority for which an advertisement will be displayed. First priority is given to advertisements identified by the user when a Poll was generated. A second priority is provided to advertisements that were identified in the category tag associated with the Poll, if any. A third priority is given to advertisements for the main category. A fourth priority is given to advertisements that were not given a category or identified by a user when the Poll was originally generated. Finally, any remaining portions of the Poll for including advertisements may be filled by any advertisement.

After a Poll including one or more voting questions has been generated and any required advertisements identified, the Poll including the various voting questions and advertisements, if any, is transmitted or otherwise served to client devices 102-108 in the form of a polling interface that may be accessed to enable users to submit voting responses to the voting questions (operation 308). Referring to FIG. 2, a processing module 212 may prepare the Poll, including any voting questions and/or advertisements, for transmission to the client devices 102-108. Initially, in one embodiment, the processing module 212 may identify unique identifiers, account numbers, validation codes, and/or some other type of information indicating which particular users are entitled to submit votes for the voting questions being transmitted. Specifically, the processing module 212 may access a database of valid users that have been registered to submit votes in response to voting questions. For example, prior to providing a response to a voting question, the generation module 210 may receive credential information from one or more of the client devices 102-108 that may be processed to verify and identify the user for which the voting question is generated. In such an embodiment, generation module 210 may transmit instructions that may be processed to generate and display one or more interactive interfaces (e.g., a user-interface) for configuring and/or receiving the credential information. Once a user is validated, the processing module 212 may transmit the Poll including any voting questions to the client devices 102-108, and the user may submit vote response to the vote management system 112. In one particular embodiment, the vote responses may be transmitted to the client devices for a limited amount of time as indicated by an administrator, such as 1 hour, 1 day, and/or any other temporal delineation. FIGS. 4E-4F illustrate example polling interfaces 436 and 448 that may be generated at the client devices 102-108 to provide a Poll including one or more questions to users. In the illustrated embodiment, the client device (e.g., 102-108) is depicted as a mobile device, although any suitable client device may be used. A user such as a Poll event participant may interact with the mobile device to provide a vote response 450 to the various voting questions 440.

In response to a Poll including one or more voting questions being transmitted to the client devices, a response is received (operation 308). As illustrated in FIG. 2, a receiving module 214 may receive the response from the client devices 102-108. Each response may include a vote in response to the voting question and unique identifier corresponding to the particular user. Subsequently, the processing module 212 may analyze the vote to determine whether it is valid. For example, each vote may be validated based on individual user account credentials, such as a unique identifier, software fingerprint biometric algorithms, and the like. The voting for any type of event may be counted according to various schemes including, but not limited to, one vote per user, cumulative voting, and the like. It is contemplated that any type of vote count mechanism may be employed to determine the outcome of a voting event. In one particular embodiment, points may be assigned to a vote response. For example, points may be awarded for participating in a voting Poll, and additional points may be awarded if the vote response qualifies as a correct answer. Users, such as administrative users, may assign, calculate, and verify points on a per Poll, or accumulated Poll basis. For example, assume an administrator of a sporting event designed three to four Polls throughout the game with each Poll having a different advertisement. Points and/or coupons may be awarded for each Poll and each Poll may award points according to an individual point system. For example, points may be awarded for participating in a Poll, selecting the correct answer in a predictive or trivia type Poll, or both. For example 25 points for participating in a poll and 50 points for selecting the correct answers. The CMS may record and calculate the accumulated points on a per user basis. The points may be accumulated by the voting application 114 of the vote management system 112, optionally, over a given period of time, such as a day, week, year, or other temporal delineation (e.g., over the length of a sporting season). Points may be used for reward redemption and/or gamafication purposes. For example, a coupon for discounts related to any advertisements corresponding to the correctly answered voting questions may automatically be generated and provided.

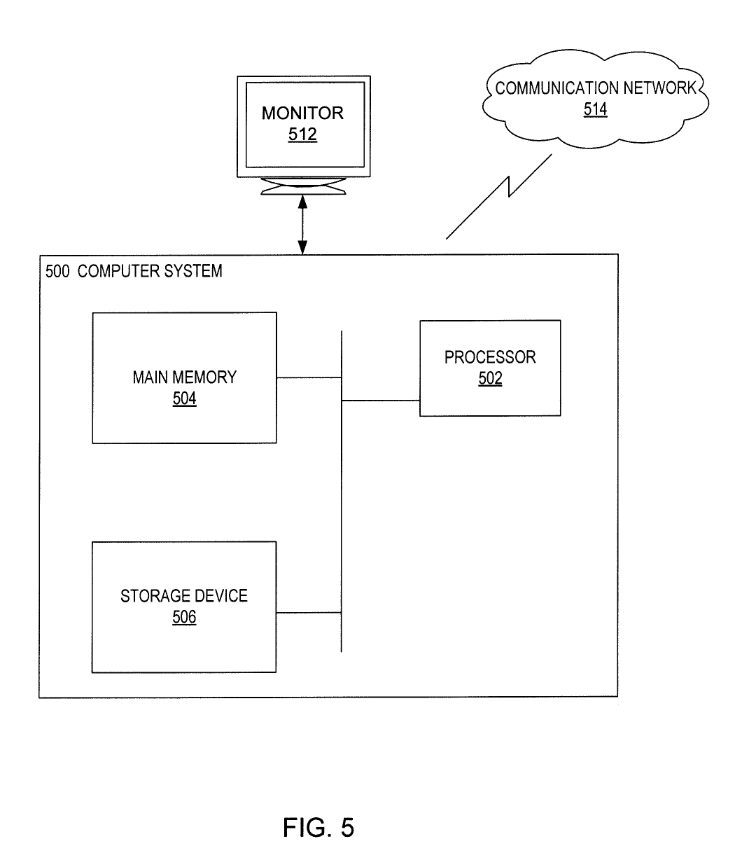

The various inventive concepts described above may be implemented on virtually any type of computer regardless of the platform being used. For example, as shown in FIG. 5, a computer system 500 includes a processor 502, associated memory 504, a storage device 506, and numerous other elements and functionalities typical of today's computers (not shown). The computer 500 may also include input means, such as a keyboard and a mouse and output means, such as a monitor 512. The computer system 500 may be connected to a local area network (LAN) or a Wide area network (e.g., the Internet), such as communication network 514, via a network interface connection (not shown). Those skilled in the art will appreciate that these input and output means may take other forms.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for voting comprising:
generating, at at least one processor, a poll including at least one voting question;
identifying, at the at least one processor, at least one advertisement corresponding to the poll;
serving, at the at least one processor, a polling interface including the at least one voting question and the at least one advertisement to at least one client device, the client device being used by a particular user; and
receiving, at the at least one processor, a response from the at least one client device, the response comprising a vote corresponding to the at least one voting question and a unique identifier associated with the particular user.

2. The method of claim 1, wherein the poll includes a poll category identifier, the method further comprising:
categorizing the advertisement by assigning the at least one advertisement a category tag, wherein serving the polling interface to include the at least one advertisement occurs when the category tag matches the poll category identifier.

3. The method of claim 1, further comprising associating the advertisement with a geographic location and wherein serving the polling interface to include the at least one advertisement occurs when the client device is identified as being within the geographic location.

4. The method of claim 1, wherein the Poll includes a time limit indicating when the poll should end, the method further comprising:
defining a plurality of answers corresponding to the at least one voting question; and
when the time limit expires, identifying at least one answer of the at least one answer as a correct answer, based on the at least one response.

5. The method of claim 4, further comprising awarding a point to the particular user when the response is the same as the correct answer.

6. The method of claim 1, wherein the at least one advertisement includes a first and second advertisement, the method further comprising:
prioritizing the first advertisement over the second advertisement when the first advertisement was directly identified when the poll was generated and the second advertisement was not directly identified.

7. A system for automatic voting comprising:
at least one processor to:
generate a poll including at least one voting question;
identify at least one advertisement corresponding to the poll;
serve a polling interface including the at least one voting question and the at least one advertisement to at least one client device, the client device being used by a particular user; and
receive a response from the at least one client device, the response comprising a vote corresponding to the at least one voting question and a unique identifier associated with the particular user.

8. The system of claim 7, wherein the poll includes a poll category identifier, the method further comprising:
categorizing the advertisement by assigning the at least one advertisement a category tag, wherein serving the polling interface to include the at least one advertisement occurs when the category tag matches the poll category identifier.

9. The system of claim 7, further comprising associating the advertisement with a geographic location and wherein serving the polling interface to include the at least one advertisement occurs when the client device is identified as being within the geographic location.

10. The system of claim 7, wherein the Poll includes a time limit indicating when the poll should end, the method further comprising:
defining a plurality of answers corresponding to the at least one voting question; and
when the time limit expires, identifying at least one answer of the at least one answer as a correct answer, based on the at least one response.

11. The system of claim 10, further comprising awarding a point to the particular user when the response is the same as the correct answer.

12. The system of claim 7, wherein the at least one advertisement includes a first and second advertisement, the method further comprising:
prioritizing the first advertisement over the second advertisement when the first advertisement was directly identified when the poll was generated and the second advertisement was not directly identified.

13. A non-transitory computer readable medium encoded with instructions for automatic voting, the instructions, executable by a processor, comprising:
generating a poll including at least one voting question;
identifying at least one advertisement corresponding to the poll;
serving a polling interface including the at least one voting question and the at least one advertisement to at least one client device, the client device being used by a particular user; and
receiving a response from the at least one client device, the response comprising a vote corresponding to the at least one voting question and a unique identifier associated with the particular user.

14. The non-transitory computer readable medium of claim 13, wherein the poll includes a poll category identifier, the method further comprising:
categorizing the advertisement by assigning the at least one advertisement a category tag, wherein serving the polling interface to include the at least one advertisement occurs when the category tag matches the poll category identifier.

15. The non-transitory computer readable medium of claim 13, further comprising associating the advertisement with a geographic location and wherein serving the polling interface to include the at least one advertisement occurs when the client device is identified as being within the geographic location.

16. The non-transitory computer readable medium of claim 13, wherein the Poll includes a time limit indicating when the poll should end, the method further comprising:
defining a plurality of answers corresponding to the at least one voting question; and
when the time limit expires, identifying at least one answer of the at least one answer as a correct answer, based on the at least one response.

17. The non-transitory computer readable medium of claim 16, further comprising awarding a point to the particular user when the response is the same as the correct answer.

18. The non-transitory computer readable medium of claim 13, wherein the at least one advertisement includes a first and second advertisement, the method further comprising:
prioritizing the first advertisement over the second advertisement when the first advertisement was directly identified when the poll was generated and the second advertisement was not directly identified.
